(19) United States
(12) Patent Application Publication
(10) Pub. No.: US 2006/0276613 A1
(43) Pub. Date: Dec. 7, 2006

(54) POLYURETHANEUREA SEGMENTED COPOLYMERS

(76) Inventors: Iskender Yilgor, Istanbul (TR); Emel Yilgor, Istanbul (TR); Derek Klinedinst, Blacksburg, VA (US); Garth L. Wilkes, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/382,832

(22) Filed: May 11, 2006

Related U.S. Application Data
(60) Provisional application No. 60/680,015, filed on May 12, 2005.

(51) Int. Cl. C08G 18/48

(52) U.S. Cl. 528/76

(57) ABSTRACT

Novel segmented polyurethaneurea copolymers were synthesized using a poly(ethylene-butylene)glycol based soft segment. Dynamic mechanical analysis (DMA), small angle X-ray scattering (SAXS) and atomic force microscopy (AFM) established the presence of a microphase-separated structure in which hard microdomains are dispersed throughout a soft segment matrix. Wide angle X-ray scattering (WAXS) and differential scanning calorimetry (DSC) results suggest the materials are amorphous. Samples that are made with HMDI/DY and have hard segment contents in the range of 16-23 wt % surprisingly exhibit near-linear mechanical deformation behavior in excess of 600% elongation. They also show very high levels of recoverability even though their hysteresis is also considerable. The materials are both melt processable and solution processable.

### RELATED APPLICATION

This application claims benefit of U.S. Pat. Application No. 60/680,015 filed May 12, 2005.

### FIELD OF THE INVENTION

This invention relates to copolymers, methods of producing segmented copolymers, and controlling properties of copolymers, especially polyurethaneurea copolymers.

### BACKGROUND OF THE INVENTION

Segmented block copolymers are widely used in several industries including automotive coatings, molded components, sporting goods manufacturing, and in the insulation business. (Bruins P F, Polyurethane Technology. New York: Interscience Publishers, 1972; Doyle E N, The Development and Use of Polyurethane Products, New York: McGraw-Hill, 1971.) The breadth in the applications for these materials can be attributed in part to their wide range of mechanical and thermal properties. That these properties can be controlled and even tailored to a specific end use makes segmented copolymers a very attractive class of materials.

As a group, segmented thermoplastic polyurethanes, as well as some polyureas and polyurethaneureas (TPUs) are a subclass of linear segmented copolymers possessing a backbone comprised of alternating soft segments (SS) and hard segments (HS). These segments typically have rather low molecular weights compared to triblock copolymers, such as the styrene-butadiene-styrene (SBS) systems, which generally possess block molecular weights of 10,000-100,000 g/mol and are prepared by anionic polymerization. (Abouzahr S, Wilkes G L, Segmented Copolymers with Emphasis on Segmented Polyurethanes, In: Folkes M J, editor, Processing, Structure and Properties of Block Copolymers, London: Elsevier Applied Science Publishers, 1985, pp. 165-207; Tyagi D, Wilkes G L, Morphology and Properties of Segmented Polyurethane-urea Copolymers prepared via t-Alcohol “Chain Extension”, In: Lal J, Mark J E, editors, Advances in Elastomers and Rubbery Elasticity, New York: Plenum Press, 1986, pp. 103-28.) The soft segments in TPUs are often, but not exclusively, polyethers or polyesters and are chosen based on desired functionality, reactivity and molecular weight. The hard segment, also low in molecular weight, is typically formed from the reaction of a diol or diamine chain extender with excess diisocyanate. The isocyanates are either aromatic or aliphatic and the choice is based on a number of factors including cost and reactivity. The specific chemistry and symmetry of the isocyanate has been shown to affect ultimate properties of the materials, and careful consideration must be given to this choice. (Gisselfaelt K, Helgee B, Macromolecular Materials and Engineering, 2003; 288(3):265-71; Singh A., Advances in Urethane Science and Technology, 1996; 13:112-39.)

Diamines are common chain extender molecules used in the synthesis of urea linkages, although other moieties such as water can also be used as is common in the production of “polyurethane” flexible foams. (Oertel G., Polyurethane Handbook: chemistry, raw materials, processing, application, properties, New York: Munich: Hanser Publishers, 1985.)

Linear polyurethaneureas are synthesized using a step growth reaction technique first developed by Otto Bayer in the late 1930's. Oertel, supra. In the more commonly used prepolymer method, linear hydroxyl terminated oligomeric polyether or polyesters are reacted with an excess of a selected diisocyanate to cap the oligomer thereby forming a urethane linkage and leaving an isocyanate functional group at each terminus, forming what is termed a “prepolymer”. This prepolymer mixture (containing additional diisocyanate) is then reacted with a diamine chain extender to form the hard segments and increase the molecular weight of the macromolecule. In general, an increase in HS content leads to increased modulus (stiffness) and enhanced tensile strength. (Sheth J P, Aneja A, Wilkes G L, Yilgor, E, Attilla G E, Yilgor I, Beyer F L, Polymer 45(20), 6919-6932 (2004); Kazmierczak M E, Fomes R E, Buchanan D R, Gilbert R D, Journal of Polymer Science, Part B: Polymer Physics 1989; 27(11):2173-87.)

The wide range of properties of segmented copolymers for polyurethanes and polyureas has been credited to microphase-separation, the process whereby hard segments segregate, forming hard microdomains in a matrix of soft segments. These microdomains are generally well dispersed throughout the soft segment matrix and act as physical crosslinks adding modulus, stiffness and strength. In block copolymer materials with non-specific interactions, an examination of the Flory-Huggins parameter helps define under what conditions microphase-separation will occur. (Bates F S, Fredickson G H, In Physics Today, 1999, p 32-38.) Such an approach, however, cannot easily be used in the case of a segmented polyurethaneurea copolymer due to specific molecular interactions promoted by hydrogen bonding between the urethane and urea groups in the HS of these materials. This is a phenomenon known by scientists familiar with polyurethane and polyurethaneurea systems.

The soft segment phase of polyurethaneurea materials usually has a glass transition temperature (T_{g}) well below room temperature and it is this phase in thermoplastic polyurethanes, polyureas and polyurethaneureas that lowers the elastic modulus and enhances elongational properties. If microphase-separation occurs and the hard phase is also well-percolated (interconnected) throughout the material, the percolation will have the effect of further increasing modulus for a given composition, but it will also promote the potential for yielding and enhanced mechanical hysteresis. In urea HS containing systems, the HS microdomains can provide further strength to the material through the development of a bidentate hydrogen bonded network, through intra- or intermolecular interactions. Quantum mechanical calculations using DFT method have shown the bond energy of bidentate urea hydrogen bonds to be 58.5 kJ/mol. (Yilgör E, Burgaz E, Yurtsever E, Yilgör I, Polymer 2002; 43:6551-59.) In contrast, polyurethane systems can only display a monodentate hydrogen bonded network between urethane groups on the same or adjacent chains and possess a lower H-bond energy of 46.5 kJ/mol. The hard segments of polyurethanes or polyureas can also display crystallization if the appropriate process history is utilized and HS symmetry exists.

Certain polyurethaneureas and synthesis methods therefore have been disclosed:

U.S. Pat. No. 6,720,403 issued Apr. 13, 2004 to Houser (DuPont) for “Polyurethaneurea and spandex comprising same” (reacting polyether which comprises the reaction product of a polymeric glycol with ortho-substituted diisocyanates and bulky diamine chain extenders);

U.S. Pat. No. 6,475,412 issued Nov. 5, 2002 to Roach (DuPont) for “Process for making polyurethaneurea powder”;

U.S. Pat. No. 6,245,876 issued Jun. 12, 2001 to Hanahata et al. (Asahi Kasei Kogyo Kabushiki Kaisha), for “Continuous molded article for polyurethaneurea and production method thereof”;

U.S. Pat. No. 6,225,435 issued May 1, 2001 to Ito, et al. (DuPont Toray), for “Stable polyurethaneurea solutions” (prepared from certain polyether glycols and aliphatic diisocyanates and ethylene diamine);

U.S. Pat. No. 6,114,488 issued Sep. 5, 2000 to Kulp et al. (Air Products and Chemicals), for “Polyurethaneurea elastomers for dynamic applications” (mixing a polyurethane prepolymer and an amine curative which is made of aminobenzoate, aromatic polyamine, and carboxylic acid);

U.S. Pat. No. 5,919,564 issued Jul. 6, 1999 to Sugaya, et al. (Asahi Kasei) for “Elastic polyurethaneurea fiber” (reaction of a polymer diol, organic diisocyanate, bifunctional amine mainly consisting of ethylene diamine and a monoamine);

U.S. Pat. No. 5,739,252 issued Apr. 14, 1998 to Kirchmeyer et al. (Bayer), for “Thermoplastic polyurethaneurea elastomers” (preparation from organic polyisocyanates and mixture containing Zerewitinoff active hydrogen atoms);

U.S. Pat. No. 5,576,410 issued Nov. 19, 1996 to Yosizato, et al. (Asahi Kashei), for “Diaminourea compound and process for production thereof and high heat resistant polyurethaneurea and process for production thereof”;

U.S. Pat. No. 5,552,229 issued Sep. 3, 1996 to Brodt, et al. (BASF Magnetics) for “Magnetic recording medium containing magnetic material dispersed in a polyurethaneurea-polyurethane binder”;

U.S. Pat. No. 5,542,338 issued Jul. 30, 1996 to Dewhurst et al. (Air Products and Chemicals) for “Fatty imidazoline crosslinkers for polyurethane, polyurethaneurea and polyurea applications”;

U.S. Pat. No. 5,541,280 issued Jul. 30, 1996 to Hanahata et al. (Asahi Kasei) for “Linear segmented polyurethaneurea and process for production thereof”);

U.S. Pat. No. 5,414,118 issued May 9, 1995 to Yosizato et al. (Asahi Kasei) for “Diaminourea compound and process for production thereof and high heat resistant polyurethaneurea and process for production thereof”;

U.S. Pat. No. 5,410,009 issued Apr. 25, 1995 to Kato, et al. (Ihara Chemical Industry Co.) for “Polyurethaneurea elastomer”;

U.S. Pat. No. 5,391,343 issued Feb. 21, 1995 to Dreibelbis, et al. (DuPont) for “Thin-walled articles of polyurethaneurea”;

U.S. Pat. No. 5,358,985 issued Oct. 25, 1994 to Dewhurst et al. (Air Products and Chemicals) for “Ionic siloxane as internal mold release agent for polyurethane, polyurethaneurea and polyurea elastomers”;

U.S. Pat. No. 5,296,518 issued Mar. 22, 1994 to Grasel et al. (Hampshire Chemical Corp.) for “Hydrophilic polyurethaneurea foams containing no toxic leachable additives and method to produce such foams” (high molecular weight, isocyanate-terminated, ethylene oxide-rich prepolymers are used to make the foams);

U.S. Pat. No. 5,288,779 issued Feb. 22, 1994 to Goodrich (DuPont) for “Polyurethaneurea solutions and spandex therefrom”;

U.S. Pat. No. 5,250,649 issued Oct. 5, 1993 to Onwumere, et al. and U.S. Pat. No. 4,948,860 issued Aug. 14, 1990 to Solomon et al. (both assigned to Becton, Dickinson) both titled “Melt processable polyurethaneurea copolymers and method for their preparation”;

U.S. Pat. No. 5,162,481 issued Nov. 10, 1992 to Reid, et al. (Minnesota Mining and Manufacturing), for “Polyurethaneurea composition”;

U.S. Pat. No. 4,504,648 issued Mar. 12, 1985 to Otani et al. (Toyo Tire & Rubber), for “Polyurethaneurea and process for preparing the same”;

U.S. Pat. Application No. 20050176879 was published Aug. 11, 2005 by Flosbach et al. (du Pont) for “Polyurethane resins with trialkoxysilane groups and processes for the production thereof”;

U.S. Pat. Application No. 2005131136 was published Jun. 16, 2005 by Rosthauser et al. (Bayer Material Science LLC) for “Soft polyurethaneurea spray elastomers with improved abrasion resistance”.

Also, the following work by Shell Oil Co. and Kraton Polymers not disclosing polyurethaneurea is mentioned for general background:

U.S. Pat. No. 6,323,299 issued Nov. 27, 2001 to Handlin et al. (Kraton Polymers U.S. LLC) titled “Method for producing mixed polyol thermoplastic polyurethane compositions” according to its abstract discloses a process for preparing a thermoplastic polyurethane resin in which the polydiene is reacted with the isocyanate at 70 to 100° C. for 10 to 60 minutes; a polymeric diol is added and the reaction proceeds at 70 to 100° C. for 60 to 150 minutes to form a prepolymer; and the chain extender is added and the reaction proceeds at 70 to 125° C. for 1 to 24 hours to form a thermoplastic polyurethane. Examples are given for prepolymers made with polyethers (polytetramethylene glycol prepolymers); high EB diol content PTMEG prepolymers; polypropylene glycol based prepolymers; polyester based prepolymers; and high EB diol content polycarbonate prepolymers.

U.S. Pat. No. 6,077,925 issued Jun. 20, 2000 to Gerard (Shell Oil Co.) titled “Structural adhesives” according to its abstract discloses a composition comprising a polyurethane obtainable by reacting a polyisocyanate having a functionality between 2-3 and a hydrogenated polybutadiene polyol having a functionality between 1.5-2.5 and a certain vinyl content. In the Example, a polymeric MDI having an isocyanate functionality of 2.7 is mixed with KRATON LIQUID L-2204 hydrogenated polybutadiene diol.

U.S. Pat. No. 5,929,167 issued Jul. 27, 1999 to Gerard et al. (Shell Oil Co.) titled “Pressure sensitive adhesives comprising thermoplastic polyurethanes” according to its abstract discloses a composition comprising a thermoplastic polyurethane (which is derived from an aromatic diisocyanate and/or a cycloaliphatic diisocyanate, a chain extender, and a polymeric diol and/or a hydrogenated polydiene diol and a hydrogenated polydiene mono-ol) and a tackifying resin. In the Examples, mixtures are prepared of KRATON Liquid Polymer L-2203 hydrogenated polydiene diol and KRATON Liquid Polymer L-1203 hydrogenated polydiene mono-ol.

U.S. Pat. No. 5,925,724 issued Jul. 20, 1999 to Cenens et al. (Shell Oil co.) titled “Use of polydiene diols in thermoplastic polyurethanes” according to its abstract discloses formation of a thermoplastic polyurethane (TPU) composition from a polydiene diol and an isocyanate by a prepolymer method. In the Examples, a linear, hydrogenated butadiene diol polymer was used to produce TPU elastomers.

U.S. Pat. No. 6,043,316 issued Mar. 28, 2000 to St. Clair (Shell Oil Co.) titled “Crosslinkable hydroxyl terminated polydiene polymer coating compositions for use on substrates and a process for preparing them.” Examples are included for effect of melamine resin and reinforcing diol type; effect of concentration of a hydroxyl terminated diene polymer in formulations containing TMPD diol with two butylated melamine resins; effect of type of hydroxyl terminated polydiene polymer; effect of styrene content in the hydroxyl terminated diene polymer; adhesion of various coating compositions to primed steel; and basecoat/clearcoat combinations.

U.S. Pat. No. 6,211,292 issued Apr. 3, 2001 to St. Clair (Shell Oil Co.) titled “Functionalized block copolymers cured with isocyanates” and in the abstract discloses an isocyanate-cured hydroxyl, acid or amine functionalized selectively hydrogenated block copolymer of a vinyl aromatic hydrocarbon and a conjugated diene.

U.S. Pat. No. 5,486,570 issued Jan. 23, 1996 to St. Clair (Shell Oil Co.) titled “Polyurethane sealants and adhesives containing saturated hydrocarbon polyols” and in the abstract discloses polyurethane sealants and adhesives made with saturated, polydihydroxylated polydiene polymers and polyisocyanates. The crosslinked polyurethane has hydrocarbon segments formed by use of substantially less than stoichiometric amounts of polyisocyanate or by addition of monohydroxylated polydiene polymers.

U.S. Pat. No. 5,922,781 issued Jul. 13, 1999 to St. Clair et al. (Shell Oil Co.) titled “Weatherable resilient polyurethane foams.” The abstract discloses production from a polydiene diol, an aliphatic or cycloaliphatic polyisocyanate, and a stabilizer.

U.S. Pat. No. 6,251,982 issued Jun. 26, 2001 to Masse et al. (Shell Oil Co.) titled “Compound rubber compositions,” and in the abstract discloses a compounded rubber composition containing a hydrogenated polydiene diol based polyurethane, a non-polar extender and at least one thermoplastic resin. The Examples disclose using a linear hydrogenated butadiene diol polymer from Shell Chemical (KLP-L2203) along with KLP-L1203, a hydrogenated polybutadiene mono-ol. The chain extenders used were BD, BEPD and TMPD. The isocyanate used was MDI.

U.S. Pat. No. 5,864,001 issued Jan. 26, 1999 to Masse et al. (Shell Oil Co.) titled “Polyurethanes made with polydiene diols, diisocyanates, and dimmer diol chain extender.”

U.S. Pat. No. 6,111,049 issued Aug. 29, 2000 to Sendijarevic et al. (Shell Oil Co.) titled “Polyurethanes having improved moisture resistance” and in the abstract discloses a synthesis using a hydrogenated polydiene diol, an isocyanate and optionally a chain extender.

U.S. Pat. No. 5,955,559 issued Sep. 21, 1999 to Handlin, Jr. et al. (Shell Oil Co.) titled “Cast polyurethane elastomers containing low polarity amine curing agents” and in the abstract discloses synthesis using a hydrogenated polydiene diol, an isocyanate, and an amine curing agent (which must be a certain hindered aromatic amine crosslinker).

U.S. Pat. No. 5,710,192 issued Jan. 20, 1998 to Hernandez (Shell Oil Co.) titled “Polydiene diols in resilient polyurethane foams.”

Also, there is mentioned U.S. Pat. Application publication no. 20060014916 (published Jan. 19, 2006) by Yilgor et al. which discloses novel synthesis techniques for making siloxane-urea segmented copolymers.

### SUMMARY OF THE INVENTION

The present inventors have advanced the field of polyurethaneureas by customizing an approach that overcomes previously problematic differences between synthesizing polyurethaneureas and synthesizing other polyurethane containing copolymers. For example, in contrast to the conventional polyether or polyester polyols, the soft segment used in the present invention may be, e.g., a saturated hydrocarbon based polyol (e.g., an ethylene-butylene based polyol (with a preferred example of an ethylene-butylene based polyol being Kraton™ Liquid L-2203)).

The present inventors hydrogenated an α,ω-hydroxy terminated polybutadiene (which was prepared by anionic polymerization), to produce a resulting amorphous soft-segment (SS) which has no significant polarity compared to polyester or polyether based systems. (See Example herein.)

The resulting polyurethaneurea product synthesized by the inventors also was notable in having a SS molecular weight of 3340 g/mol as opposed to typical values of 1000-2000 g/mol used in the majority of linear segmented polyurethanes and conventional polyurethaneureas. Based on observing and considering the above-mentioned properties of synthesized polyurethaneurea materials, the present inventors concluded that microphase separation is strongly favored for typical hard segments based on polyurethane, polyurea or polyurethaneurea chemistry.

The invention in an exemplary embodiment provides a polyurethaneurea copolymer comprising a poly(ethylene-butylene)glycol based soft segment (such as, e.g., a polyurethaneurea further including an organic diisocyanate with 8 to 15 carbon atoms; a polyurethaneurea further including an organic diamine chain extender with 2 to 12 C atoms in its backbone; etc.).

The invention in another exemplary embodiment provides a polyurethaneurea copolymer, comprising a microphase-separated structure in which hard urethaneurea microdomains are dispersed throughout a soft segment matrix (such as, e.g., amorphous polyurethaneurea copolymers; polyurethaneurea copolymers comprising a poly(ethylene-butylene)glycol based soft segment; polyurethaneurea copolymers including an organic diisocyanate with 8 to 15 carbon atoms; polyurethaneurea copolymers including a chain extender with 2 to 12 C atoms in its backbone; etc.).

The invention in a further exemplary embodiment provides a method of synthesizing a polyurethaneurea copolymer, comprising: reacting at least one poly(ethylene-butylene)glycol based polyol with at least one diisocyanate (preferably, an organic diisocyanate with 8 to 15 carbon atoms), and a diamine (preferably an organic diamine chain extender with 2 to 12 C atoms in its backbone) and forming a polyurethaneurea (such as, e.g., a polyurethaneurea copolymer comprising a poly(ethylene-butylene)glycol based soft segment; a polyurethaneurea copolymer comprising a microphase-separated structure in which hard urethaneurea microdomains are dispersed throughout a soft segment matrix; etc.).

### BRIEF SUMMARY OF THE DRAWINGS

FIG. 1: Plots of E′ and tan δ for inventive polyurethaneurea HMDI/DY/16, HMDI/DY/19, and HMDI/DY/23 systems.

FIG. 2: SAXS scans showing first order interference peaks of inventive polyurethaneurea HMDI/DY/16, HMDI/DY/19, and HMDI/DY/23 materials with spacings of 84, 89 and 93 Å respectively.

FIG. 3: DSC traces of first and second heats of HMDI/DY/19 (an inventive polyurethaneurea). The lack of clear melting peaks indicates that there is no detectable crystallinity.

FIG. 4: Representative tensile curves of samples HMDI/DY/16, HMDI/DY/19, and HMDI/DY/23 (inventive polyurethaneureas).

FIG. 5: Three tensile curves for sample HMDI/DY/19 (inventive polyurethaneurea), showing near linear behavior beginning at low deformations.

FIG. 6: 3-cycle hysteresis loops for sample HMDI/DY/19 (inventive polyurethaneurea).

FIG. 7: Stress relaxation curves for HMDI/DY (inventive polyurethaneurea) materials after an initial stretch to 600%.

FIG. 8: Tensile curves of HMDI/DY (inventive polyurethaneurea) materials comparing solvent cast and remolded materials.

FIG. 9: Plots of E′ and tan δ for the inventive polyurethaneurea HDI/EDA/8 and HDI/DY/9 samples.

FIG. 10: SAXS scans showing first order interference peaks for the HDI/ED/8 and HDI/DY/9 (inventive polyurethaneurea) materials with spacings of 123 and 125 Å respectively.

FIG. 11: DSC trace of HDI/DY/9 (inventive polyurethaneurea) sample showing no evidence of crystallinity.

FIGS. 12A-B: AFM phase images of HDI/DY/9 inventive polyurethaneurea sample (FIG. 12A) showing a well percolated nano-stranded morphology and of HDI/EDA/8 inventive polyurethaneurea sample (FIG. 122B) showing nano-stranded morphology.

FIG. 13: AFM phase image of HDI/EDA/8 (inventive polyurethaneurea) after remolding in a hot press at 200° C.

FIG. 14: Tensile curves of HDI materials comparing solvent cast and remolded materials.

FIG. 15: Chemical structures for four compounds, HMDI, HDI, EDA and DY, which were used, respectively, in preparing exemplary inventive polyurethaneurea copolymers.

### DETAILED DESCRIPTION OF THE PREFERRED EMBODIMENTS OF THE INVENTION

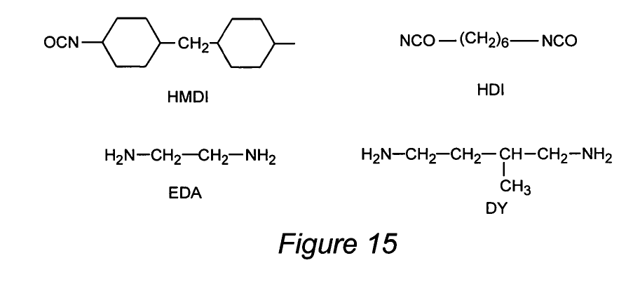

Examples of an organic diisocyanate with 8 to 15 carbon atoms which may be used in the invention include, e.g., 1,6-hexamethylene diisocyanate (HDI); 1,4-cyclohexyl diisocyanate (CHDI); p-phenylene diisocyanate (PPDI); toluene diisocyanate (TDI); m-phenylene diisocyanate (MPDI); diphenylmethane diisocyanate (MDI); hydrogenated diphenyl methane diisocyanate (HMDI); isophorone diisocyanate (IPDI); naphthalene diisocyanate (NDI); tetramethylxylilene diisocyanate (TMXDI), etc. In preparing the inventive linear segmented copolymers of the Examples herein, two different diisocyanates were employed: hydrogenated diphenyl methane diisocyanate (HMDI) and hexamethylene diisocyanate (HDI). The chemical structures for both the diisocyanates HMDI and HDI are given in FIG. 15.

Examples of an organic diamine chain extender with 2 to 12 C atoms in its backbone include, e.g., ethylene diamine (EDA); 1,3-diaminopropane; 1,4-diaminobutane; 1,5-diaminopentane; isophorone diamine (IPDA); 1,6-hexamethylene diamine; bis(4-aminocyclohexyl)methane (PACM); 2-methyl-1,5-diaminopentane (DY); etc. The chain extenders used in the Examples herein were ethylene diamine (EDA) (see FIG. 15 for the chemical structure) and 2-methyl-1,5-diaminopentane (see FIG. 15 for the chemical structure) which is sold under the name Dytek® (DY). In the Examples, therefore, the role of symmetry in the behavior of linear segmented polyurethaneureas can be seen, as EDA is a symmetric molecule whereas DY is asymmetric.

The mentioned novel polyurethaneurea copolymers (such as, e.g., (such as, a polyurethaneurea copolymer comprising a poly(ethylene-butylene)glycol based soft segment; a polyurethaneurea copolymer comprising a microphase-separated structure in which hard urethaneurea microdomains are dispersed throughout a soft segment matrix; etc.) may be synthesized by a method comprising reacting at least one poly(ethylene-butylene)glycol based polyol with at least one diisocyanate (preferably, an organic diisocyanate with 8 to 15 carbon atoms), and a diamine (preferably an organic diamine chain extender with 2 to 12 C atoms in its backbone) and forming a polyurethaneurea. Preferably, the polyol, diisocyanate, and diamine are combined in equivalents to produce polyurethaneureas of Mw ranging from 15,000 to 120,000 g/mol. Such synthesis of polyurethaneurea copolymers preferably includes a chain extending step, such as a chain extending step using a diamine chain extender with 2 to 12 carbon atoms (such as, e.g., ethylene diamine (EDA); 1,3-diaminopropane; 1,4-diaminobutane; 1,5-diaminopentane; isophorone diamine (IPDA); 1,6-hexamethylene diamine; bis(4-aminocyclohexyl)methane (PACM); 2-methyl-1,5-diaminopentane (DY); etc.). Such synthesis of polyurethaneurea copolymers preferably includes a step of forming poly(ethylene-butylene)glycol based polyol by hydrogenation of an α-ω-hydroxy terminated polybutadiene.

Examples of uses for the inventive segmented polyurethaneureas include, e.g., use in biomaterials (such as, e.g., artificial blood vessels, other blood contacting devices, etc.); use in high-performance textile fibers; use in anti-fouling marine coatings; etc.

The invention may be further appreciated with reference to the following experimental examples, without the invention being limited to those examples.

Experimentation

An experimental study was designed having two foci: (1) examination of the properties of segmented polyurethaneurea films comprised of a non-polar ethylene-butylene (EB) soft segment and an HMDI-DY hard segment (with particular attention to the way solid-state properties are affected by HS content in the range (16 wt %-23 wt %)); and (2) the effect the choice of chain extender has on the properties of ethylene-butylene soft segment based polyurethaneureas. In the following experimentation, HDI is used as the diisocyanate and the chain extender used is either EDA or DY.

Materials

Bis(4-isocyanatocyclohexyl)methane (HMDI) (Bayer) and 1,6-hexamethylene diisocyanate (HDI) (Aldrich) with purities of greater than 99.5% were used. Hydroxy terminated Kraton™ Liquid-L-2203 (supplied by Kraton Inc.) was used. The average functionality and the number average molecular weight (<M_{N}>) of Kraton™L-2203, as determined by ¹H-NMR, were 1.92 and 3340 g/mol respectively. It also had a very narrow molecular weight distribution of 1.03, as determined by SEC. Reagent grade ethylene diamine (EDA) was purchased from Aldrich. 2-Methyl-1,5-diaminopentane (DY) was provided by Du Pont. HPLC grade tetrahydrofuran (THF), toluene, isopropyl alcohol (IPA), and tetrahydrofuran (THF) (Aldrich) were all used as received. The catalyst, Dibutyltin dilaurate (T-12) is a product of Witco.

Polymer Synthesis

Polymerizations were conducted in three-neck, round bottom, Pyrex reaction flasks equipped with an overhead stirrer, addition funnel and nitrogen inlet. All copolymers were prepared by using the two-step, prepolymer method. To prepare the prepolymer, calculated amounts of diisocyanate and Kraton™ L-2203 were introduced into the reactor, stirred and heated. When the mixture reached 80° C., 200 ppm of dibutyltin dilaurate (T-12) in toluene was added as catalyst. Prepolymer formation was monitored by FT-IR spectroscopy, following the disappearance of the broad hydroxyl stretching peak around 3450 cm⁻¹ and formation of the N—H peak and C═O peaks near 3300 and 1720 cm⁻¹ respectively. After the completion of prepolymer formation, the system was cooled to ambient conditions and the prepolymer was dissolved in toluene or THF. Then it was further cooled to 0° C. in an ice-water bath and diluted with isopropyl alcohol. For chain extension, a stoichiometric amount of diamine chain extender (DY or EDA) was weighed into an Erlenmeyer flask, dissolved in IPA, introduced into the addition funnel and added dropwise into the prepolymer solution at 0° C., under strong agitation. Completion of reactions was determined by monitoring the disappearance of the isocyanate absorption peak around 2270 cm⁻¹ with a FTIR spectrophotometer. Reaction mixtures were homogeneous and clear throughout the polymerizations.

Table 1 provides the compositional characteristics of the poly(ethylene-butylene)glycol based polyurethaneureas prepared in this study. SS chain length is constant at 3340 g/mol. HS chain length, as shown on the last column of Table 1 varies between 280 and 1020 g/mol, depending on the hard segment content. The convention for sample designation used is as follows: Diisocyanate/chain extender/HS wt %. Therefore, HMDI/DY/16 refers to a polyurethaneurea with an ethylene/butylene SS, HMDI and DY chain extender with a HS content of 16.2 wt %. HDI/DY/9 and HDI/EDA/8 have identical molar compositions. The small difference in HS content is due to the difference in the molecular weight of the diamine.

TABLE 1
Compositions and average hard segment lengths
of poly(ethylene-butylene)glycol (Mn = 3340
g/mol) based polyurethaneurea copolymers

| Sample | | Chain | HS content | HS <Mₙ> |
|---|---|---|---|---|
| code | Diisocyanate | extender | (wt %) | (g/mol) |
| HMDI/DY/16 | HMDI | DY | 16.2 | 645 |
| HMDI/DY/19 | HMDI | DY | 19.4 | 800 |
| HMDI/DY/23 | HMDI | DY | 23.4 | 1020 |
| HDI/DY/9 | HDI | DY | 8.7 | 320 |
| HDI/EDA/8 | HDI | EDA | 7.8 | 80 |

Solution based films were cast from a toluene/IPA mixture into Teflon molds, covered with glassware to slow down the solvent evaporation, and placed into a 60° C. oven overnight. The molds were then removed from the drying oven and placed into a vacuum oven at room temperature for at least two days to complete the solvent removal. The samples were kept under vacuum at room temperature when not in use. Interestingly all films were also compression moldable at 200° C., at ca. 300 psi resulting in clear, monolithic, uniform films.

Atomic Force Microscopy (AFM)

AFM was performed using a Digital Instruments (now Veeco) Dimension 3000 atomic force microscope with a NanoScope IIIa controller. The microscope was operated at ambient temperature in the tapping mode using Nanodevices TAP150 silicon cantilever probe tips. The tips possessed a 5 N/m spring constant and a resonant frequency of ca. 100 kHz. The free air amplitude was normally set at 2.8 V. Some samples, however, necessitated the use of a much higher free air amplitude of ca. 8.0 V. The tapping force was varied by controlling the set point for each scan and was varied depending on sample conditions. Typically, a value was chosen so that the set point ratio fell in the range 0.4-0.7, constituting hard to medium tapping strengths. Scans were done at a frequency of 1 Hz.

Dynamic Mechanical Analysis (DMA)

DMA was performed on a Seiko DMS 210 tensile module with an attached auto-cooler for precise temperature control. Rectangular samples measuring 10 mm in length and 4.5-6.5 mm in width were cut from the cast films. Under a dry nitrogen atmosphere, the films were deformed using a frequency of 1 Hz. The temperature was increased from −150 to 200° C. at a rate of 2° C./min. Soft segment glass transition temperatures reported by the DMA methodology were denoted as the location of the peak in the Tan δ vs. temperature plots.

Tensile Testing

The stress-strain behavior of the films was measured using an Instron Model 4400 Universal Testing System controlled by Series IX software. A bench-top die was used to cut 2.91×10 mm dogbone samples from the larger cast films. These dogbones were then tested to failure at a crosshead speed of 25 mm/min and their load vs. displacement values recorded. Three samples were measured and their results were averaged to determine modulus, yield strength, and strain-at-break for each of the five materials. In addition to testing the materials to failure, hysteresis measurements were also made. For this test, the dogbone shaped samples were stretched to 600% strain at a crosshead speed of 25 mm/min and then immediately returned to its initial position of 0% strain at the same rate. This loading-unloading cycle was repeated twice more to produce a three-cycle hysteresis test. Lastly, an Instron was also used to perform stress relaxation experiments. In this case, the sample was rapidly stretched to a strain of either 25% or 600% and held while the decay in load as a function of time was recorded.

Wide Angle X-Ray Scattering (WAXS)

Photographic flat WAXS studies were performed using a Philips PW 1720×-ray diffractometer emitting Cu—K_{α} radiation with a wavelength of λ=1.54 Å. The operating voltage was set to 40 kV and the tube current set to 20 mA. The sample to film distance was set at 47.3 mm for all samples. Direct exposures were made using Kodak Biomax MS film in an evacuated sample chamber. X-ray exposures lasted four hours. Sample thickness ranged from 12-14 mils for the three HMDI/DY samples and 19.5-20 mils for the HDI/ED and HDI/DY samples.

Small Angle X-Ray Scattering (SAXS)

Pin-hole collimated SAXS profiles were collected at ambient temperature using a Rigaku Ultrax 18 rotating anode X-ray generator operated at 40 kV and 60 mA. A pyrolytic graphite monochromator was used to filter out all radiation except the Cu—K_{α} doublet, with an average wavelength of λ=1.5418 Å. The camera used 200 μm, 100 μm and 300 μm pinholes for X-ray collimation. Two-dimensional data sets were collected using a Molecular Metrology 2D multi-wire area detector, located approximately 65 cm from the sample. After azimuthal averaging, the raw data were corrected for detector noise, sample absorption, and background noise. The data were then placed on an absolute scale using a type 2 glassy carbon sample 1.07 mm thick, previously calibrated at the Advanced Photon Source at the Argonne National Laboratory, as a secondary standard. All the SAXS profiles presented have been masked in the low scattering vector region where the beam stop influenced the profiles. The absolute intensity data are presented as a function of the magnitude of the scattering vector, s, where s=2 sin(θ)/λ, and 2θ is the scattering angle.

Differential Scanning Calorimetry (DSC)

DSC was used to determine potential melting behavior of the segmented polyurethaneureas and was also used as a second method for determining SS glass transition temperatures. DSC experiments were conducted on a Seiko DSC 220C with an attached auto-cooler for precise temperature control. Samples weighing 10-15 mg were heated in a nitrogen atmosphere from −150 to 200° C. at 10° C./min, quenched to −150° C. at 10° C./min, and reheated to 200° C. at 10° C./min.

Experimental Results

HMDI/DY Materials as a Function of Hard Segment Content

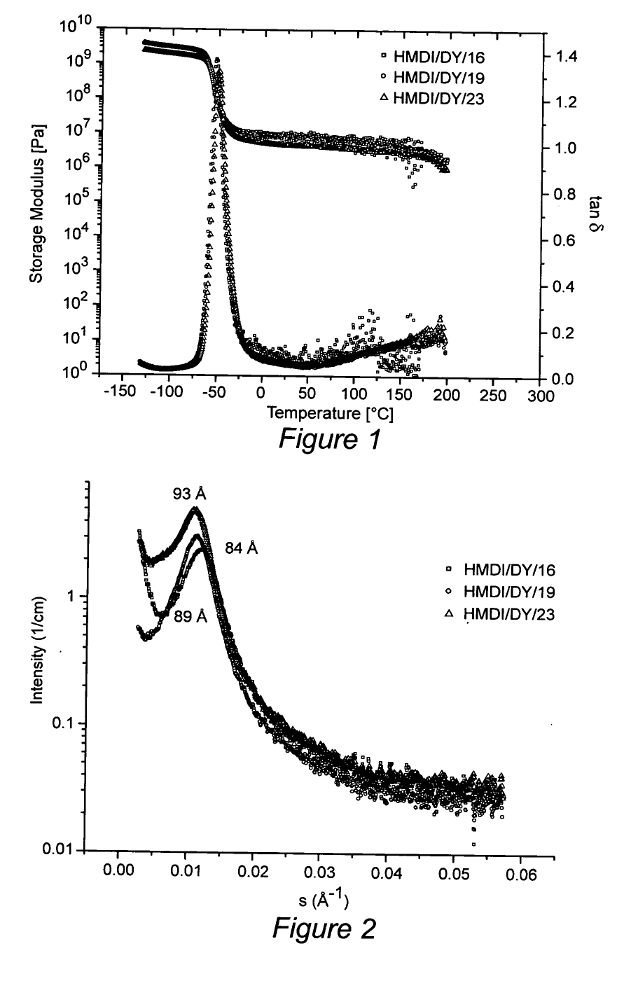

The three HMDI/DY based TPUs which varied by only 7.2 wt % in hard segment content were found to have some similar physical properties as well as some important differences. DMA analysis (FIG. 1) provided initial insight into the structural features of this series. At temperatures below −63° C., all three samples behaved as glassy solids with storage modulus (E′) values in excess of 3×10⁹ Pa. As the samples were heated, the SS phase of each went through a glass transition at ca. −50° C. Accordingly, E′ distinctly decreased as the sample passed through T_{g} and approached an average value of roughly 10⁷ Pa. Each sample maintained approximately this level of modulus until it softened beyond the sensitivity of the DMA at temperatures in the range of 150° C. Thus, the “service window” for these HMDI/DY materials, as defined by the E′ plateau between the soft segment T_{g} and the hard segment softening point, is quite broad (−30° C. to +150° C.) and the storage modulus is relatively temperature insensitive. The relatively high modulus of the material in this region is one indication of a microphase-separated structure. The upper temperature limit of the plateau is attributed in part to the bidentate hydrogen bonding between urea linkages on adjacent HS. The bond energy for bidentate bonding between urea groups has been previously calculated to be 58.5 kJ/mol (Yilgor et al. (2002), supra). As expected, HS bonding serves to enhance segmental cohesion at higher temperatures. DMA analysis (FIG. 1) clearly supports a well-defined microphase separation in these copolymers.

A microphase-separated morphology in the polyurethaneureas was further confirmed by SAXS (FIG. 2). Increasing the HS content in these materials promotes a corresponding increase in the volume fraction of the HS domains. This increase in volume fraction must change the microphase-separated morphology, by an increase in the size, shape or number of the microphase-separated HS domains. Here, increasing HS content results in an increase in domain spacing measured by SAXS, where materials with HS contents of 16, 19, and 23% have spacings of 84, 89 and 93 Å respectively. This is most simply explained by an increase in domain size, as is expected in this composition range, whether from a lengthening or thickening of the hard domains. An increase in the number of domains could cause a decrease in the domain spacing, contrary to the observed shifts in the SAXS data.

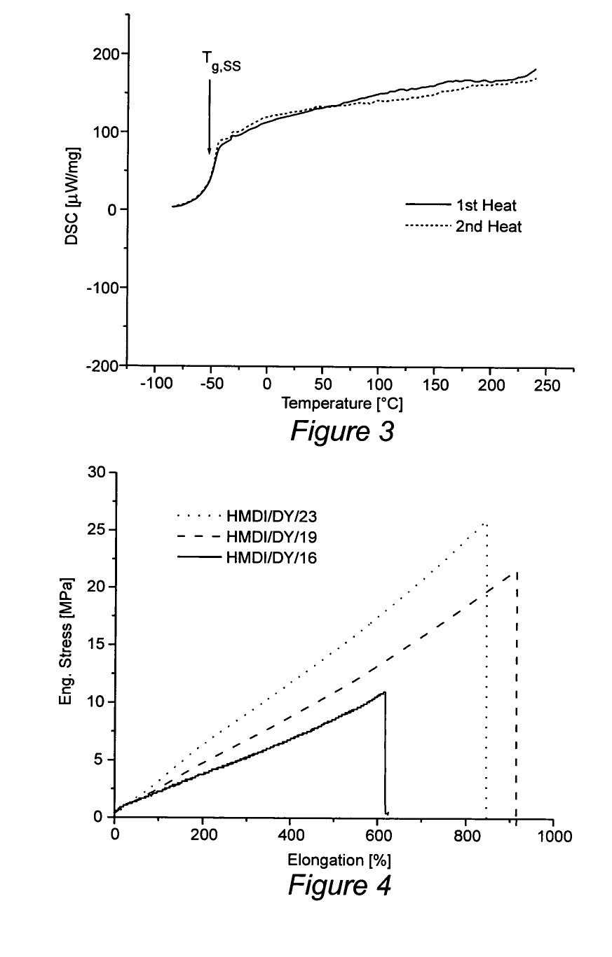

HS crystallinity was not expected in view of the asymmetric chain extender, DY; both WAXS and DSC studies gave direct support for this hypothesis. The WAXS patterns (not shown) obtained at ambient temperature of all three materials in the series showed only a broad amorphous halo and no sign of discrete diffraction rings attributable to a crystalline structure. Furthermore, the DSC traces of each material in the series, while showing T_{g}'s consistent with the Tan δ peak in the DMA data, showed no endothermic peaks, nor were any expected, that could be assigned to any melting of the HS phase. Representative DSC traces are shown in FIG. 3 for HMDI/DY/19.

As seen in other studies on conventional segmented polyurethaneurea systems, increasing HS content generally leads to both higher modulus values and higher tensile strengths and can also often improve toughness in certain ranges of HS content. (Gisselfaelt, supra; Amitay-Sadovsky E, Komvopoulos K, Ward R, Somorjai G A, Applied Physics Letters 2003; 83(15); Harris R F, Joseph M D, Davidson C, Deporter C D, Dais V A, Journal of Applied Polymer Science 1990; 41(3-4):509-25; Lin S B, Hwang K S, Tsay S Y, Cooper S L, Colloid and Polymer Science 1985; 263(2): 128-40.) This was also the case in the inventive systems of this Experimentation. A representative tensile curve for each material is presented in FIG. 4. A systematic increase occurred in each of these variables with the growing HS content. The modulus increased as expected with growing HS content as reflected by the rise in slope of the successive stress-strain curves as the HS content rose from 16 to 23 wt %. An average tensile strength for each material was determined by averaging the results of three tests. For the three HS contents 16, 19, and 23 wt %, the average tensile strengths were 10, 19 and 24 MPa respectively. It should be noted that while higher tensile strengths with increasing HS content were expected, the increase in HS wt % from 16% to 23% led to a ca. 150% rise in tensile strength. This significant increase suggests that the level of HS phase connectivity may be quite sensitive in this HS content range. A second cause of this increase in tensile strength we believe arises from the enhanced cohesiveness of the HS domains caused by the larger average HS lengths as the HS wt % increases. The larger HS should lead to an increase in the stress the inventive polyurethaneurea material can withstand before fracture of the material occurs.

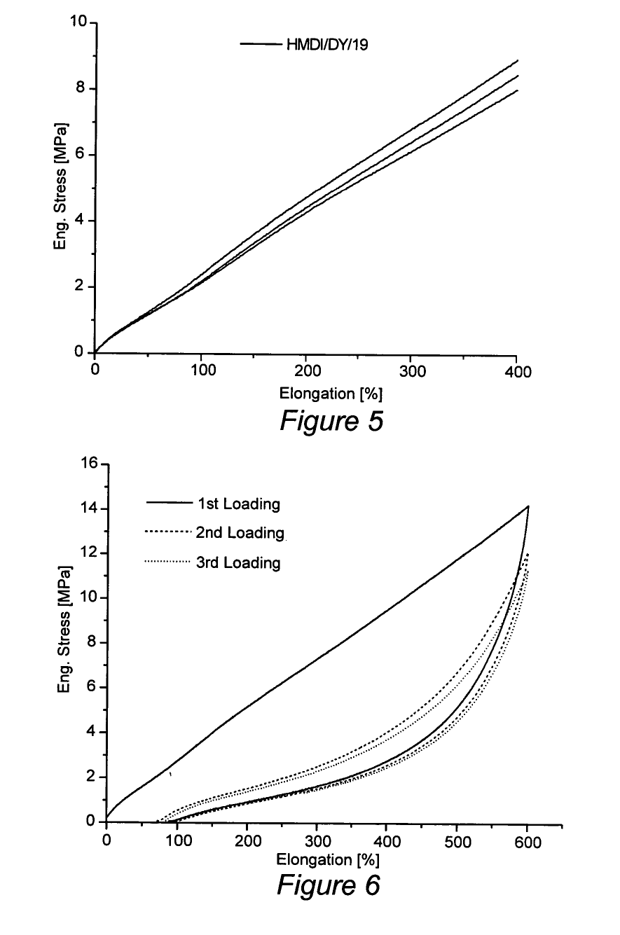

A particularly interesting feature of these tensile curves for the inventive polyurethaneurea materials are their nearly linear, almost Hookean stress-strain response starting at very low deformations and continuing to failure which occurs at levels of extension exceeding 600% (FIG. 4). An expanded view of three tensile samples of the 19 wt % HS material is shown in FIG. 5. The present inventors know of no other fully polymeric system that displays such near-linear behavior while undergoing tensile deformation to such high elongations. Increasing the ratio of HS to SS should also increase the toughness values, T, of these materials, which were determined by the area under the stress-strain curves. This area was calculated by integration of the stress with respect to the strain i.e.

$$T = {\int }_{0}^{{ɛ}_{B}} σ ⅆ ɛ \qquad ( Eq 1 )$$

where ε_{B} represents the strain at break. A Hookean behavior is assumed because these materials show nearly linear deformation, and a value of the stress σ can be substituted in Equation 1 by use of Hooke's Law,
σ=Eε (Eq 2)
Thus, Eq 1 becomes:

$$T = {\int }_{0}^{{ɛ}_{B}} E ɛ ⅆ ɛ \qquad ( Eq 3 )$$

The modulus is constant and can be removed from the integrand leaving:

$$T = E {\int }_{0}^{{ɛ}_{B}} ɛ ⅆ ɛ \qquad ( Eq 4 )$$

which leads to:

$$T = \frac{E {ɛ}_{B}^{2}}{2} \qquad ( Eq 5 )$$

Therefore, if Hookean, the toughness is directly proportional to the square of the strain in these materials. The toughness of the HMDI/DY/16, HMDI/DY/19 and HMDI/DY/23 samples was calculated to be 33, 99, and 110 MPa respectively. As a comparison, the values calculated by integration of the area under the actual stress-strain curve were, 34, 95, and 107 MPa respectively. Therefore, calculated values vary only 3-4% from the integrated values thereby providing further support of the near-linear Hookean behavior these three inventive polyurethaneurea systems display. The increase in HS wt % from 16% to 23% has increased toughness values by ca. 200%.

The hysteresis of these materials was also explored. An example of one such test on the 19 wt % HS material is provided in FIG. 6. Again, the Hookean type behavior began immediately at low deformations and the response maintained near-linearity to 600% strain. The sample was then unloaded and recovered much of its initial length though the unloading response was nonlinear. The stress reached a value of zero before the crosshead fully returned to its zero strain position. Therefore there exists some amount of permanent set in the material due to the irrecoverable energy lost in the deformation. This value of set, just below 100% strain, is not, however fully permanent. The sample continues to recover after the first loading-unloading cycle and would continue to do so if it were not immediately stretched a second time. For this reason the onset of stress during the second loading occurred at an earlier strain than where the stress dropped to zero during the first unloading cycle. Upon the second deformation, it was evident that the loading curve did not trace the previous unloading curve. The second deformation does not display the same near-linear stress-strain response of the first extension, nor was it expected to, due to the disruption of the HS structure that occurred as a result of the first loading. Clearly considerable structural modification was done to the structure that was responsible for the near-linear response during the initial extension. All subsequent loading curves show strain hardening behavior and the responses are very similar to one another. This is clear from the increase in the slope of the loading curves as the materials are again elongated to high strains. After the third and final loading-unloading cycle, the permanent set could be measured more accurately. Immediately after its removal from the testing frame, the residual strain was measured to be 2 mm, or 20%. However, twenty-four hours later the sample had recovered almost all of its initial length at ambient temperature and was measured to be 10.5 mm in length (indicating only a 5% permanent set).

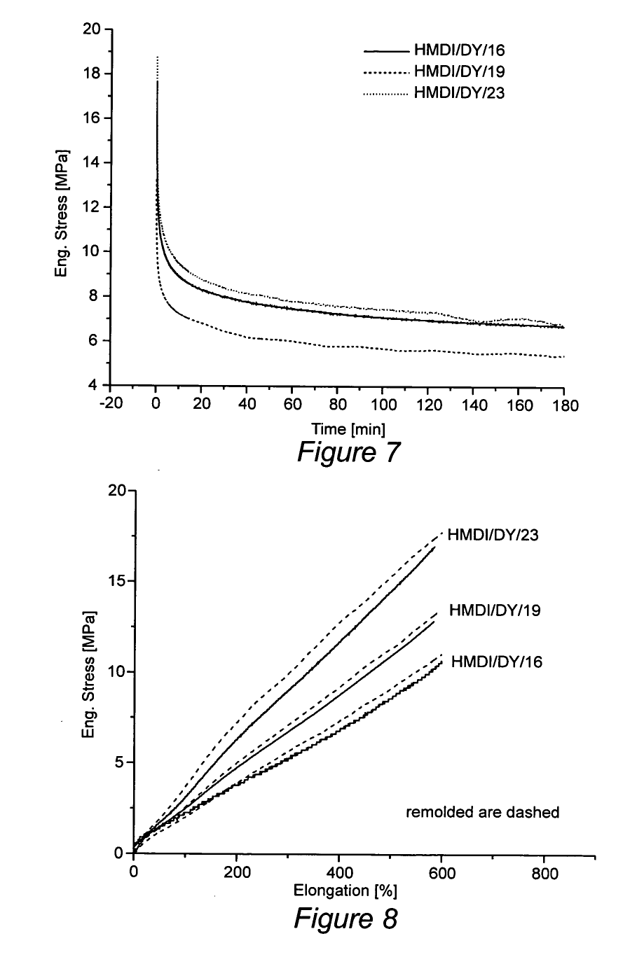

The amount of recovery observed for these inventive polyurethaneurea samples motivated further consideration of the morphological features of these materials. Clearly, based on the hysteresis results, this morphology is softened greatly through modification of the HS phase with extension. To address how this disruption of structure influences the time dependence or relaxation behavior of the system, some stress relaxation measurements were undertaken at 600% extension—the results being shown in FIG. 7. All three materials were stretched at a rate of 100 nm/min so that the loading was completed in 36 seconds. After extension ended all three materials experienced stresses of ca. 20 MPa. The samples were then held at that length for at least three hours, until the rate of change of the stress level was nearly zero. It appears that two very distinct relaxation mechanisms are occurring, one dominating the short time scale and a second occurring over a much longer time. All samples show that they maintain a stress in excess of 5 MPa after this three hour period.

Having completed all of the characterization techniques discussed above, the ability of the inventive polyurethaneurea sample materials to be reprocessed (an important feature of thermoplastic elastomers) was investigated. Unused pieces of each inventive polyurethaneurea sample material were placed in a hydraulic press with platen temperatures of 200° C. Each tested polyurethaneurea material was found to be easily reprocessable as the pressing resulted in a clear and uniform film for each system. The tensile properties of the remolded films were then tested for comparison with the solvent cast films (FIG. 8). The remolded films display very similar deformation properties to the solvent cast films up to 600% elongation. The modulus values are very close as the deformation curves almost lie atop one another. In addition, the unique near-Hookean linearity of the curves at low levels of deformation is maintained after remolding. Also important is the fact that the remolded materials retain the characteristic of high recoverability.

The similarity in mechanical behavior is an important observation given the different physical and thermal histories of the samples. In some block copolymer systems, such as many of the SBS triblock materials, solvent cast materials have been shown to contain very different structure than their melt processed counterpart. (Bagrodia S, Wilkes G L, Journal of Biomedical Materials Research 1976; 10: 101-11; Huang H, Hu Z, Chen Y, Zhang F, Gong Y, He T, Wu C, Macromolecules 2004; 37(17):6523-30.) In this Experimentation for the inventive polyurethaneurea films, the HMDI/DY films appear to have a comparable structure, irrespective of whether they were produced with the THF/IPA solvent or have a melt history.

HDI/EDA/8 and HDI/DY/9 Materials

The two materials, HDI/EDA/8 and HDI/DY/9, differ from those previously discussed in two respects. First, these latter two were prepared using HDI as the diisocyanate in place of HMDI and second, EDA (symmetric) was chosen as the chain extender for one of the samples as opposed to DY (asymmetric) thereby allowing the effect of chain extender symmetry to be examined. In order to understand the influence of chain extender structure and symmetry on the properties, both samples were prepared with the same molar compositions, which is [HDI]/[Kraton]/[CE]=3/2/1. The difference in the HS content comes from the higher MW of DY.

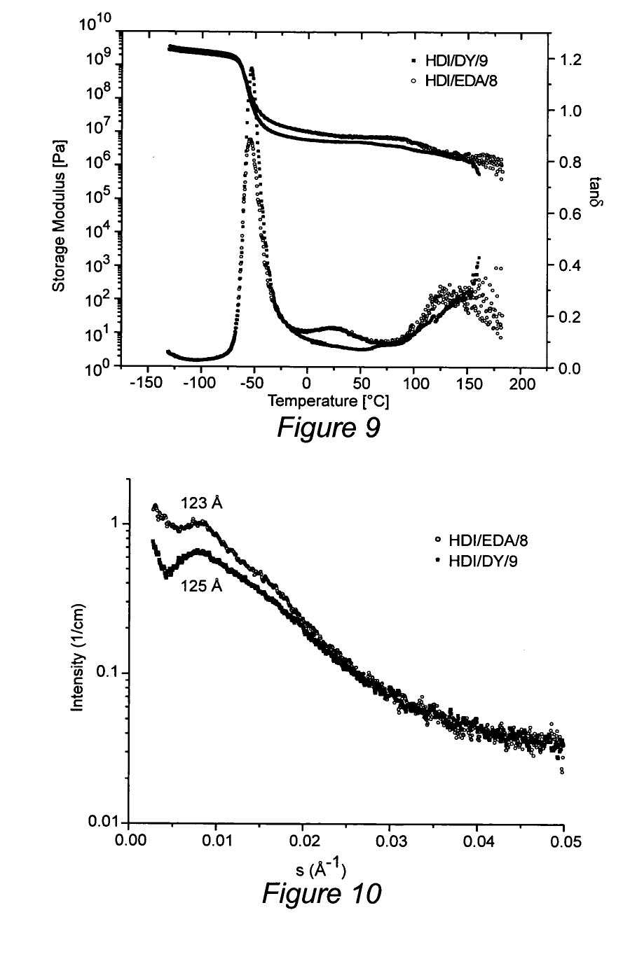

The DMA traces of these two samples (FIG. 9) show results somewhat similar to the HMDI/DY systems with regard to the SS T_{g}'s. In this case, the respective SS T_{g}'s are −53° C. for HDI/DY/9 and −54° C. for HDI/EDA/8. As the sample is heated through T_{g} the material softens considerably and E′ decreases from ca. 10⁹ Pa to ca. 10⁷ Pa, the same general range of values as noted for the HMDI/DY materials. As with the HMDI/DY samples, the magnitude of the modulus in the plateau region is ascribed to the presence of a microphase-separated structure. An additional conclusion can be drawn based on the similarity of the modulus values of these two sets of materials. Recall that the HDI based materials have a much lower HS content (ca. 8% as opposed to 16-23%). This implies that the HDI/DY/9 and HDI/EDA/8 materials must have some level of higher interconnectedness of the hard microphase to account for the similar E′ values.

These materials also display distinct differences from the HMDI/DY materials. Following the SS T_{g}, there is a relatively flat and broad plateau in modulus between −30° C. and +100° C., a smaller thermal window than was observed for the HMDI/DY systems. Therefore, the plateau in these materials spans only 130° C. compared to the 180° C. span of the HMDI/DY materials which possessed both longer HS and a higher HS content. Recall from Table I that the HMDI based materials had HS Mn values between 645 and 1020 g/mol whereas the HDI/DY/9 and HDI/EDA/8 have HS Mn values of 320 and 280 g/mol respectively. The breadth of the rubbery plateau is again due in part to the bidentate hydrogen bonding between urea linkages on adjacent chains. Though each set of polyurethaneureas contains both monodentate and bidentate hydrogen bonds, the combined effect of the lower HS contents and lower HS molecular weights in the HDI based materials is to reduce the number of urea linkages available for bonding. The smaller number of hydrogen bonds is expected to lower the upper temperature limit as the HS domains of the HDI materials begin to soften sooner than their HMDI based counterparts. The use of HDI rather than HMDI may also influence differences in hard segment cohesiveness/packing behavior. Specifically, this reduction in upper temperature modulus could also be due to the melting of the symmetric HDI, although no direct evidence of a crystalline HS was obtained for either material as will be addressed shortly. Above 100° C. the materials each began softening until ca. 150° C., where both have softened beyond the sensitivity of the DMA. Two key differences are also apparent in the temperature dependent Tan δ responses of the HDI/DY/9 and HDI/EDA/8 materials. The first difference is the very small peak at ca. 25° C. in the HDI/EDA/8 sample. This peak disappears after annealing at 100° C. and may result from residual solvent in the freshly cast material even though this sample had been given the same preparation history as the others. The second difference, unaffected by annealing, is the disparity in magnitude of the Tan δ peak at the T_{g} for these materials. The peak in HDI/DY/9 sample has a magnitude of ca. 1.2 while the HDI/EDA/8 sample has a peak value of ca. 0.9. While not excessively large, this roughly 20% difference in peak height coupled with the similar peak breadths, does imply that the soft segment phase of the HDI/DY/9 sample is less restricted in its motion than the soft segment phase of its HDI/EDA/8 counterpart. The breadths of the Tan δ peaks are essentially the same.

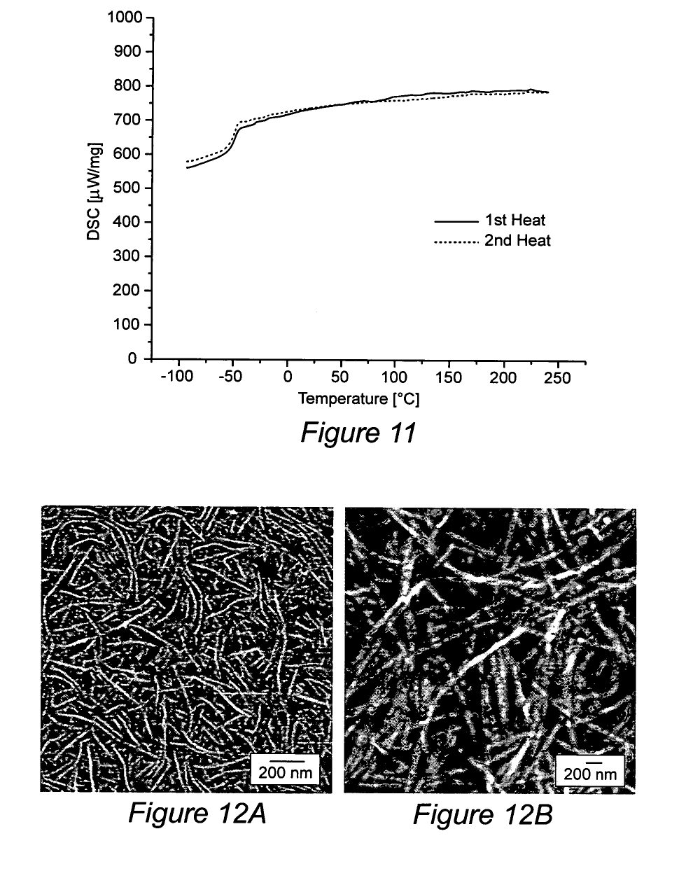

The microphase-separated morphologies of both the HDI/EDA/8 and HDI/DY/9 materials were further confirmed by SAXS measurements (FIG. 10). From those scans, well-defined first order interference peaks were observed at 123 Å and 125 Å respectively. However, the angular locations of these peaks raise the question of why the spacings of these lower HS content materials are appreciably larger than the HMDI series discussed previously, which had spacings of 84-93 Å. A tentative explanation is that the difference may be due to, what is on average, a shorter overall HS length in the HDI series. This may result in some of the shortest hard segments dissolving into the SS phase. Indeed, based on the Mₙ of these segments, they are only 1-3 segments long indicating that dissolution of hard segments may be more likely in these materials. Dissolved HS could effectively lengthen the SS (doubling the effective SS molecular weight to ca. 6600 g/mol), resulting in a larger spacing. In addition to shifting the location of the peaks to smaller angles, some dissolved HS would broaden the interference peaks in the SAXS profiles. That this too is measured for the HDI materials (FIG. 10) lends further support to the explanation proffered.

It is clear from both the DMA and SAXS data that microphase-separation occurs for each polyurethaneurea material. In further examination of the HDI based materials, neither WAXS nor DSC (FIG. 11) showed any evidence of crystallinity for either sample. This is qualified with the understanding that the very low levels of HS content may make any crystalline structure that might exist exceedingly difficult to measure.

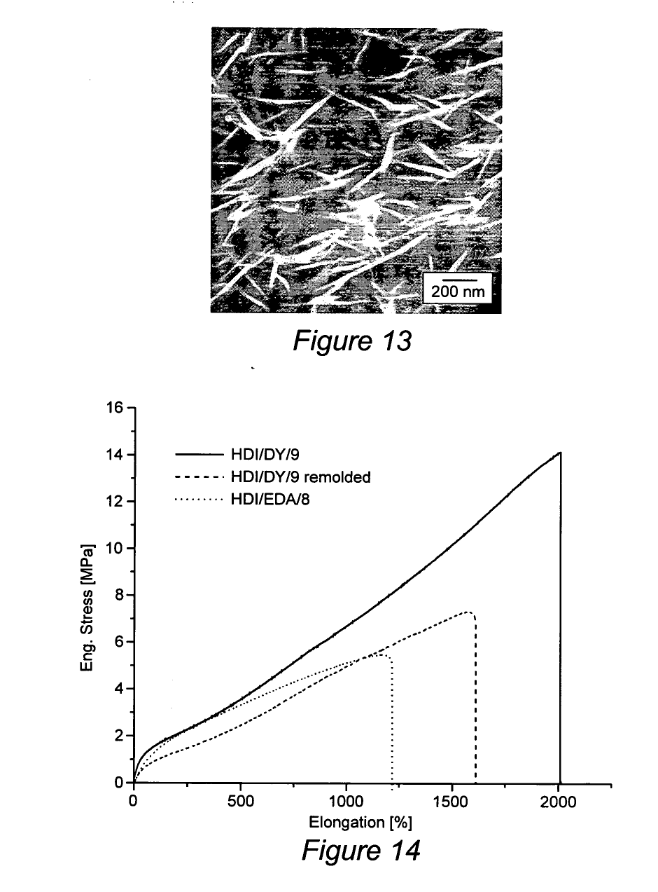

AFM was used for obtaining visual evidence of the microphase structure. AFM phase images were obtained of a well-percolated HS microphase-separated structure for both samples. FIG. 12a shows the very clear ribbon-like structure of HDI/DY/9 while FIG. 12b shows the stranded structure of HDI/EDA/8. The three images provide direct visual evidence of two distinct phases: a well-dispersed, interconnected, stranded or ribbon-like hard phase represented by the light portions of the image, embedded in a soft segment matrix represented by the darker portions of the image. The DMA behavior of the HDI/EDA/8, HDI/DY/9 and the three HMDI/DY materials suggests that they have somewhat similar microphase-separated structures, despite obtaining clear AFM scans only for the two HDI based samples. In addition to the cast film samples discussed thus far, a second film sample of HDI/EDA/8 was obtained by remolding unused portions of the solution cast material in a hot film press. After molding, AFM was performed on the films and the same percolated, microphase-separated structure was found to exist in these films indicating that the material can be reprocessed although the level of HS percolation appears to be somewhat less than within the solvent cast film (FIG. 13).

Despite the similarities between the IIDI/EDA/8 and HDI/DY/9 samples discussed thus far, there is a surprisingly large difference in the polyurethaneurea materials with respect to their ambient stress-strain properties. Representative stress-strain curves are shown for each tested polyurethaneurea material in FIG. 14. Both materials display a deviation from linearity at low strains followed by essentially linear behavior until break, in contrast to the near Hookean behavior of the HMDI/DY materials. The tensile curves also show the HDI/DY/9 material to have over twice the tensile strength of the HDI/EDA/8 material i.e., 13 MPa versus 5.5 MPa. Furthermore, the HDI/DY/9 sample achieves higher strains at break, 2000% versus 1200%, than the HDI/EDA/8. None of the HMDI/DY materials surpassed even 1000% strain before failure. Lastly, the HDI/DY/9 material displayed a toughness more than three times greater than that of the HDI/EDA/8 sample, 141 MPa to 43 MPa respectively.

The tensile properties of the remolded polyurethaneurea materials were also measured. Again, the remolded DY based material behaved similarly to the solvent cast material, the tensile curves having roughly the same shape. However, the remolded material did not achieve the same ultimate stress. Consistent with the AFM images, the lower stresses achieved in these tests suggest that there is less percolation of the hard segment phase throughout the remolded samples.

To summarize the experimentation, novel segmented polyurethaneurea copolymers based on HMDI, an ethylene-butylene soft segment and HS contents between 16 and 23% were prepared. Depending on the materials used for this invention, the HS content of the polyurethaneurea can be ideally adjusted to between 5% and 50%. These materials developed microphase separated morphologies with wide service windows as measured with SAXS and DMA. In addition to the broad temperature insensitive E′ plateau, they each displayed a unique, near linear, Hookean-like stress-strain response until fracture at very high levels of strain, in excess of 900% in some cases. The materials were found to be reprocessable as new clear, transparent films were made by melt pressing unused portions of the solvent cast material. The remolded materials were found to display the same near-linear, Hookean behavior upon deformation. The similarities in tensile behavior indicate that similar microstructures are attained for these materials whether they are fabricated as a result of solvent casting or melt pressing.

Ethylene/butylene based segmented polyureas were also synthesized using HDI as the diisocyanate and EDA or DY as the chain extender. These materials had HS contents between 8 and 9%. Both also developed percolated, ribbon-like microphase-separated morphologies with broad service windows, though less broad than the HMDI materials. The more narrow service window is attributable to the lower HS content and shorter HS length in the HDI based materials. This necessarily reduces the number of bidentate bonds in the material and lowers its upper temperature limit. The shorter HS is also thought to be responsible for the different interdomain spacings as measured with SAXS, whereby the shorter HS leads to dissolution of some hard segments into the SS matrix and “effectively lengthens” the SS, shifting the interference peak to higher length scales. Direct visual evidence of the microphase-separated morphology was obtained by AFM for each of the HDI based materials. Each of these materials was also found to be reprocessable in a melt press as well, producing clear, uniform films.

Thus, in this Experimentation, novel segmented polyurethaneurea copolymers were synthesized using a poly(ethylene-butylene)glycol based soft segment and either hydrogenated diphenyl methane diisocyanate (HMDI) or hexamethylene diisocyanate (HDI) in addition to either ethylene diamine (EDA) or 2-methyl-1,5-diaminopentane (DY) as the chain extender. Dynamic mechanical analysis (DMA), small angle X-ray scattering (SAXS) and atomic force microscopy (AFM) established the presence of a microphase-separated structure in which hard microdomains are dispersed throughout a soft segment matrix in the samples of this Example. Wide angle X-ray scattering (WAXS) and differential scanning calorimetry (DSC) results suggest the materials in this Example are amorphous. Samples for this Example 1 that were made with HMDI/DY with hard segment contents in the range of 16-23 wt % surprisingly exhibit near-linear mechanical deformation behavior in excess of 600% elongation; these samples also show very high levels of recoverability even though their hysteresis is also considerable. The materials of this Example have all proven to be melt processable in addition to solution processable.

While the invention has been described in terms of its preferred embodiments, those skilled in the art will recognize that the invention can be practiced with modification within the spirit and scope of the appended claims.

What we claim as our invention is:

1. A polyurethaneurea copolymer comprising a poly(ethylene-butylene)glycol based soft segment.

2. The polyurethaneurea of claim 1, further including an organic diisocyanate with 8 to 15 carbon atoms.

3. The polyurethane urea of claim 2, wherein the organic diisocyanate is selected from the group consisting of 1,6-hexamethylene diisocyanate (HDI), 1,4-cyclohexyl diisocyanate (CHDI), p-phenylene diisocyanate (PPDI), toluene diisocyanate (TDI), m-phenylene diisocyanate (MPDI), diphenylmethane diisocyanate (MDI), hydrogenated diphenyl methane diisocyanate (HMDI), isophorone diisocyanate (IPDI), naphthalene diisocyanate (NDI), and tetramethylxylilene diisocyanate (TMXDI).

4. The polyurethaneurea of claim 1, further including an organic diamine chain extender with 2 to 12 C atoms in its backbone.

5. The polyurethane urea of claim 4, wherein the organic diamine chain extender is selected from the group consisting of ethylene diamine (EDA), 1,3-diaminopropane, 1,4-diaminobutane, 1,5-diaminopentane, isophorone diamine (IPDA), 1,6-hexamethylene diamine, bis(4-aminocyclohexyl) methane (PACM) and 2-methyl-1,5-diaminopentane (DY).

6. The polyurethaneurea of claim 2, further including an organic diamine chain extender with 2 to 12 C atoms in its backbone.

7. The polyurethaneurea of claim 6 wherein the organic diamine chain extender is selected from the group consisting of ethylene diamine (EDA), 1,3-diaminopropane, 1,4-diaminobutane, 1,5-diaminopentane, isophorone diamine (IPDA), 1,6-hexamethylene diamine, bis(4-aminocyclohexyl) methane (PACM) and 2-methyl-1,5-diaminopentane (DY).

8. A polyurethaneurea copolymer, comprising a microphase-separated structure in which hard urethaneurea microdomains are dispersed throughout a soft segment matrix.

9. The polyurethaneurea copolymer of claim 8, comprising a poly(ethylene-butylene)glycol based soft segment.

10. The polyurethane urea of claim 8, including an organic diisocyanate with 8 to 15 carbon atoms.

11. The polyurethane urea of claim 8, wherein the organic diisocyanate is selected from the group consisting of 1,6-hexamethylene diisocyanate (HDI), 1,4-cyclohexyl diisocyanate (CHDI), p-phenylene diisocyanate (PPDI), toluene diisocyanate (TDI), m-phenylene diisocyanate (MPDI), diphenylmethane diisocyanate (MDI), hydrogenated diphenyl methane diisocyanate (HMDI), isophorone diisocyanate (IPDI), naphthalene diisocyanate (NDI) and tetramethylxylilene diisocyanate (TMXDI).

12. The polyurethaneurea of claim 8, including a chain extender with 2 to 12 C atoms in its backbone.

13. The polyurethaneurea of claim 12, wherein the chain extender is selected from the group consisting of ethylene diamine (EDA), 1,3-diaminopropane, 1,4-diaminobutane, 1,5-diaminopentane, isophorone diamine (IPDA), 1,6-hexamethylene diamine, bis(4-aminocyclohexyl) methane (PACM) and 2-methyl-1,5-diaminopentane (DY).

14. The polyurethane urea of claim 8, including (A) a poly(ethylene-butylene)glycol based soft segment, (B) a diisocyanate, and (C) a chain extender with 2 to 12 carbon atoms.

15. The polyurethaneurea of claim 14, wherein the diisocyanate (B) is selected from the group consisting of 1,6-hexamethylene diisocyanate (HDI), 1,4-cyclohexyl diisocyanate (CHDI), p-phenylene diisocyanate (PPDI), toluene diisocyanate (TDI), m-phenylene diisocyanate (MPDI), diphenylmethane diisocyanate (MDI), hydrogenated diphenyl methane diisocyanate (HMDI), isophorone diisocyanate (IPDI), naphthalene diisocyanate (NDI), and tetramethylxylilene diisocyanate (TMXDI); and the chain extender (C) is selected from the group consisting of ethylene diamine (EDA), 1,3-diaminopropane, 1,4-diaminobutane, 1,5-diaminopentane, isophorone diamine (IPDA), 1,6-hexamethylene diamine, bis(4-aminocyclohexyl) methane (PACM) and 2-methyl-1,5-diaminopentane (DY).

16. A method of synthesizing a polyurethaneurea copolymer, comprising: reacting at least one poly(ethylene-butylene)glycol based polyol with at least one diisocyanate, and a diamine and forming a polyurethaneurea.

17. The synthesis method of claim 16, wherein the diisocyanate is selected from the group consisting of 1,6-hexamethylene diisocyanate (HDI), 1,4-cyclohexyl diisocyanate (CHDI), p-phenylene diisocyanate (PPDI), toluene diisocyanate (TDI), m-phenylene diisocyanate (MPDI), diphenylmethane diisocyanate (MDI), hydrogenated diphenyl methane diisocyanate (HMDI), isophorone diisocyanate (IPDI), naphthalene diisocyanate (NDI), and tetramethylxylilene diisocyanate (TMXDI).

18. The synthesis method of claim 15, including a chain extending step.

19. The synthesis method of claim 18, in which the chain extending step uses a diamine chain extender with 2 to 12 carbon atoms selected from the group consisting of ethylene diamine (EDA), 1,3-diaminopropane, 1,4-diaminobutane, 1,5-diaminopentane, isophorone diamine (IPDA), 1,6-hexamethylene diamine, bis(4-aminocyclohexyl)methane (PACM) and 2-methyl-1,5-diaminopentane (DY).

20. The synthesis method of claim 15, including a step of forming poly(ethylene-butylene)glycol based polyol by hydrogenation of an α-ω-hydroxy terminated polybutadiene.
